(19) United States
(12) Patent Application Publication
(10) Pub. No.: US 2014/0024004 A1
(43) Pub. Date: Jan. 23, 2014

(54) MEDICAL TRAINING DEVICE AND METHOD

(71) Applicants: Christina Virkelyst Tvermoes, Copenhagen O (DK); Kristian Ask Aabenhus, Kgs. Lyngby (DK); Christian Matula, Giesshubl (AT); Antonio De Ieva, Wien (AT)

(72) Inventors: Christina Virkelyst Tvermoes, Copenhagen O (DK); Kristian Ask Aabenhus, Kgs. Lyngby (DK); Christian Matula, Giesshubl (AT); Antonio De Ieva, Wien (AT)

(73) Assignee: TAKEDA NYCOMED AS, Asker (NO)

(21) Appl. No.: 14/009,616

(22) PCT Filed: Apr. 3, 2012
(86) PCT No.: PCT/DK2012/050104

§ 371 Date: Oct. 3, 2013

(30) Foreign Application Priority Data
Apr. 5, 2011 (EP) 11161165.3

(51) Int. Cl. G09B 23/30

(52) U.S. Cl. CPC G09B 23/30
USPC 434/270

(57) ABSTRACT

The present invention relates to a medical training device, preferably being shaped as at least a part of a human or animal skull. The training device comprises at least three elements: an element imitating the skull, an element imitating soft tissue, typically being a brain or a part thereof, and an element imitating a meninge or part thereof, preferably being the dura mater. The invention also relates to a method of training surgeons.

### FIELD OF THE INVENTION

The present invention relates to a medical training device, preferably being shaped as at least a part of a human or animal skull. The training device comprises at least three elements: an element imitating the bone, an element imitating soft tissue, typically being a brain or a part thereof, and an element imitating a meninge or part thereof, preferably being the dura mater.

The invention also relates to a method of training surgeons.

### BACKGROUND AND OBJECTS OF THE INVENTION

In the field of medical surgical training, surgeons are often trained on medical “dummy” models where the surgeon wishing to perform or teach a new or difficult procedure can perform the operation first on a “dummy” model as opposed to using a cadaver. However, for certain surgical procedures, such as neurosurgical procedures, there is a lack of available medical training models.

FR 2 885 440 discloses a mannequin head for e.g. moped manufacturer. The head has a hollow shell with an artificial hollow skull-cap, in the form of a human skull, filled with a gel simulating the cerebral matter and covered externally by a false skin. A acceleration recording device records the acceleration of the skull-cap. An evaluation device evaluates the deformations of the skull-cap, and has strain gauges integrated against the skull-cap. Although the device according to FR 2 885 440 simulates the cerebral matter and includes a false skin, it is found non-suited as a surgical training device.

Thus, the present inventors have developed a surgical training device to be used for surgical training of neurosurgeons. It is further an object of the present invention to provide an alternative to the prior art.

### SUMMARY OF THE INVENTION

Thus, the above described object and several other objects are intended to be obtained in a first aspect of the invention by providing a medical training device comprising at least three elements:
an outer element imitating an outer bony structure of a human or animal body
an inner element imitating a human or animal organ and
an intermediate element arranged between the outer element and the inner element and imitating a meninge, preferably being the dura mater, of a human or animal body,
   wherein
said intermediate element being elastic and preferably arranged in a tension state so that a puncture or fracture applied to the intermediate element results in an enlargement of the puncture or fracture.

By the elasticity of and the tension in the intermediate element, the contraction of e.g. the dura mater occurring when penetrated can be imitated in a cost effective and non-harmful manner, allowing e.g. a surgeon sufficient training sessions until the various operations to be performed e.g. during penetration of meninges have been familiarised with.

In the present context, imitating has preferably been used to denote an element having mechanical characteristics, such as shape, elasticity, density and/or brittleness similar to the real element in question, thereby allowing a user of devices according to the present invention to become acquainted with forces and actions needed in order to manipulate the real element in question. Imitating has preferably also been used for the mechanical response provided by an element imitating a real element.

In a second aspect, the invention relates to a training method comprising executing the following steps on a device according to the first aspect of the invention:
fixating the intermediate layer prior to providing a penetration imitating a surgery opening in the intermediate layer by suturing the intermediate layer to the outer element along a rim of a through going opening in the outer element.
providing the penetration of the intermediate layer inside a region defined by the through going opening in the outer element,
applying dressing, typically being TachoSil® to the penetration made in the intermediate layer.

Further embodiments and aspects of the invention are presented below as well as in the dependent claims.

### BRIEF DESCRIPTION OF THE FIGURES

The various aspects according to the invention will now be described in more detail with regard to the accompanying figures. The figures show ways of implementing the present invention and are not to be construed as being limiting to other possible embodiments falling within the scope of the attached claim set.

FIG. 1 is an illustration of first embodiment of a medical training device according the invention where the medical training device imitates a human head,

FIG. 2 is an illustration of a cross sectional view along plane A-A of FIG. 1 and discloses inter alia a way of providing tension to the intermediate layer,

FIG. 3 is an illustration of a cross sectional view along plane A-A of FIG. 1 and discloses inter alia another way of providing tension to the intermediate layer,

FIG. 4 is an illustration of elements of a preferred embodiment of a training device 1, except the intermediate layer 4, in a non-assembled state,

FIGS. 5-12 show a further embodiment according to the invention and show surgical procedure using the medical training device.

### DETAILED DESCRIPTION OF AN EMBODIMENT

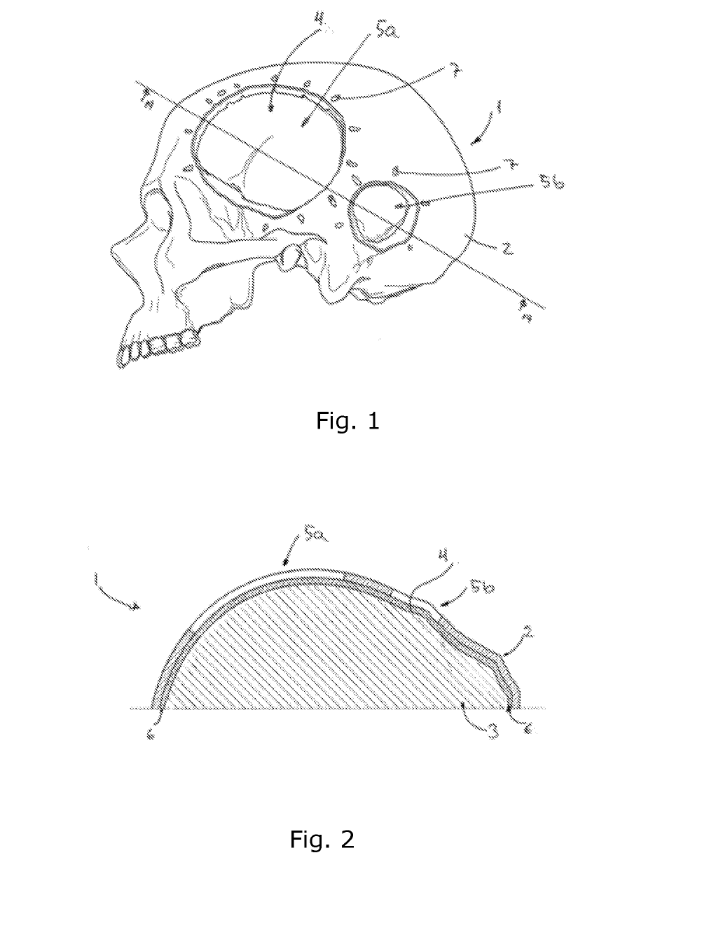

Referring to FIG. 1 illustrating a first embodiment of a medical training device 1 according to the invention, the medical training device 1 is embodied as a half skull without the jaw bone. Skin, eyes hair and other details are also not represented in the device 1.

The device comprises three elements:
an outer element 2 imitating bony structure of the head being the skull,
an inner element 3 imitating a brain (not visible in FIG. 1)
an intermediate element 4 imitating the meninges or the dura mater thereof of a head

The outer element 2 is formed as a shell defining a cavity and the inner element 3 is arranged inside the shell. The intermediate element 4 is arranged between the outer and inner elements 2, 3. The outer element 2 is made from plastic preferably having stiffness in the order of the stiffness of bone in a human skull. Two through going openings 5a, 5b are provided in the outer element 2. These through going openings are extending through the outer element 2 and allowing access to the intermediate layer 4 from the outside of the outer element 2. These through going openings may be closed or covered by suitable shaped elements.

The intermediate layer 4 is made from latex to imitate the elasticity of the dura mater and has typically a thickness of 0.5 mm.

The inner element 3 is typically a solid structure made from silicone to reflect the elasticity of a human brain. The exterior of the inner element 3 and the cavity defined by the outer element 2 are mutually shaped so as to imitate the fit between a human skull and the brain with a dura mater being arranged between the elements. In many practical embodiments, this means that the outer dimensions of the inner element 3 and the inner dimensions of the cavity defined by the outer element 2 are identical or the dimensions of the inner element 3 are slightly smaller than the cavity, typically in the order of the thickness of the intermediate layer 4.

In a human head, the dura mater is in a tension state and a cut, fraction, puncture or the like in the dura mater results in that the dura mater contracts at least in the area of the cut. To imitate such contraction of the dura mater, the intermediate layer 4 is preferably arranged between the outer element 2 and the inner element 3 in a tension state. Due to the elasticity, provided in preferred embodiments by producing the intermediate element 4 from latex, of the intermediate element 4, this contraction effect can be imitated as a contraction of the latex if punctured, fractured, cut or the like.

The tension of the intermediate layer 4 may be obtained in different manners, some of which will be disclosed with reference to FIG. 2.

FIG. 2 discloses a cross sectional view along plane A-A of FIG. 1. Same numerals as used in FIG. 1 have been used to identify same elements and details in FIG. 2. FIG. 2 shows inter alia the inner element 3 imitating the brain, the outer element 2 imitating the bony structure of a skull, and the intermediate element 4 imitating the dura mater. For clarity reasons, the bores 7 are not disclosed in FIG. 2.

In order to provide the tension to the intermediate layer a number of possibilities are available. A first way of providing a tension is disclosed in FIG. 2 and comprises a fixation 6 in the bottom part of the device 1. The fixation 6 is preferably provided by a contraction being provided by mutually shaping the inner element 3 and the outer element 2 so that once the inner element 3 is inserted the outer element 2, the distance between the outer surface of the inner element 3 and inner surface of the outer element is smaller than the thickness of the intermediate element 4. Thus, by stretching the intermediate element 4 over the inner element 3 and inserting the inner element 3 with the stretched intermediate element 4 into the cavity defined by the outer element 2, the fixation 6 will keep the intermediate element fixed in a stretched state. In addition to or alternative to provide tension, the fixation 6 may provide a fluid tight sealing between the intermediate element 4 and the inner element 3.

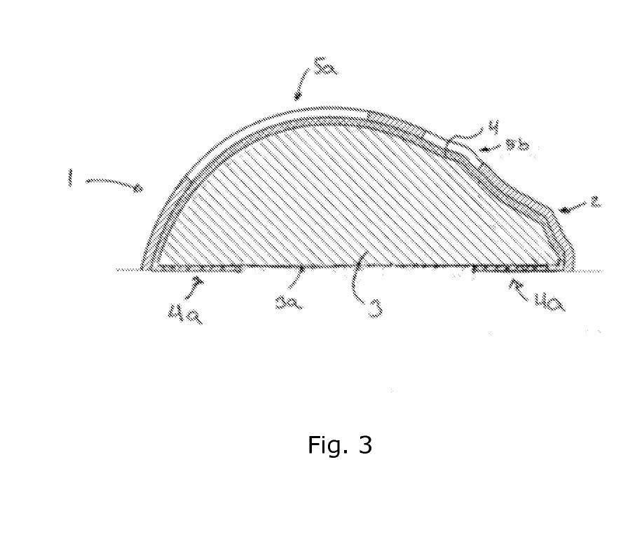

A second way of providing a tension to intermediate layer is disclosed in FIG. 3. Same numerals as used in FIG. 1 have been used to identify elements and details in FIG. 3. FIG. 3 shows inter alia the inner element 3 imitating the brain, the outer element 2 imitating the bony structure of a skull, and the intermediate element 4 imitating the dura mater. For clarity reasons, the bores 7 are not disclosed in FIG. 3. In this embodiment, the intermediate element 4 is balloon-shaped having a mouth piece 4a. The volume of the intermediate element 4 in a non-tensioned state is made smaller than the volume of the inner element 3.

Tension is provided by squeezing the inner element 3 into the interior of the balloon-shaped intermediate element 4 through the mouth piece 4a and arranging the mouth piece 4a at the bottom 3a of inner element 3; the stretching needed to accommodate the inner element 3 provides a tension in the intermediate element 4. The tension thereby provided in the intermediate element 4 will be present although the inner element 3 with the intermediate element 4 is not arranged inside the outer element 2. The size of the mouth piece 4a is selected so that the inner element 3 is easily squeezed into the intermediate element 4 often resulting in that a part of the bottom 3a of the inner element 3 is not covered by the intermediate element as indicated in the figure.

In addition or alternative to provide tension, the mouth piece may provide a fluid tight sealing between the intermediate element 4 and the inner element 3. Sealing may be enhanced by applying glue or the like between the mouth piece 4a and the bottom of the inner element 3a.

In a further embodiment (not shown in the figures) of the medical training device, the inner element 3 and the outer element 2 is mutually shaped to provide a firm fitting of the inner element 3 into the outer element 2. Thereby tension provided to the intermediate element 4, e.g. by stretching manually the intermediate element 4 over the inner element 3 prior to insertion into the outer element 2, is maintained by the firm fit.

The medical training device may preferably comprise retaining elements (not shown) for keeping the inner element 3 inside the outer element 2. Such retaining element may preferably be clips, hooks or the like.

Referring again to FIG. 1, the outer element 2 comprises a number of bores 7 provided along the rims of the through going openings 5a and 5b. These bores 7 are sloping and extend from a position away from the rim of the through going openings 5a and 5b to the edge between the inner surface of the inner element and the surface of the through going openings 5a and 5b. The purpose of these bores 7 are to allow fixation of the intermediate layer 4 to the rim of the through going openings 5a and 5b by sutures. Such sutures are provided by feeding a needle with thread through the bores 7 and intermediate element 4 and tie a knot on the thread. By this fixation, the intermediate layer 4 will be kept in its position outside the through going openings 5a and 5b upon providing an opening in the intermediate element imitating a surgery opening, although some contraction will occur in the intermediate element 4 inside the regions defined by the through going openings 5a and 5b.

Training by use of the medical training device may follow different routes. An aim of training device disclosed in the figures herein is to train surgeons in making brain surgery. This includes the delicate task of penetrating the meninges and in particular the dura mater. Another important training is to close surgery openings provided in the meninges after the surgery has been performed.

A training session could accordingly preferably comprise the following steps:
fixating the intermediate layer 4 prior to providing a surgery opening by suturing the intermediate layer 4 to the outer element 2,
providing a penetration of the intermediate layer inside the regions defined by the through going openings 5a and 5b,
applying dressing, typically being TachoSil® to the penetration made in the intermediate layer 4

While the embodiments shown in the figures have been provided with the through going openings 5a and 5b as well as the bores 7, other embodiment of the invention comprising an outer element having no such through going openings 5a and 5b or bores 7. In yet further embodiments the through going openings 5a and 5b have been provided whereas the bores 7 are not provided. In addition, the position and number of through going openings 5 and bores 7 may be varied according to the training to be performed.

Thus, if it is also a task to train surgeons to provide the through going opening(s) 5 and/or the bores 7, these are not provided in the outer element 2 and a training session could accordingly comprise the one or more steps of providing such through going opening(s) 5 and/or bores.

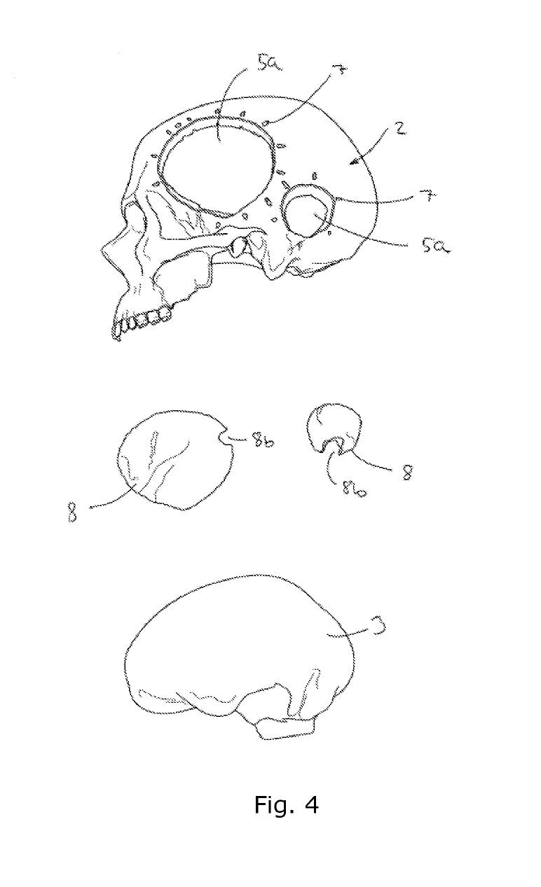

In yet a further embodiment, plugs 8 (see FIG. 4) are provided in and matching the through going opening(s) 5 thereby imitating the bone element(s) being cut free during surgery. The training session may then include the step of removing such plug(s) prior to fixating and penetrating the intermediate layer 4.

FIG. 4 shows elements of a preferred embodiment of a training device 1, except the intermediate layer 4, in a non-assembled state. FIG. 4 shows in details, the outer element 2, the through going openings 5a and 5b, the bores 7, plugs 8 with cut-outs 8b, and the inner element 3 imitating a brain.

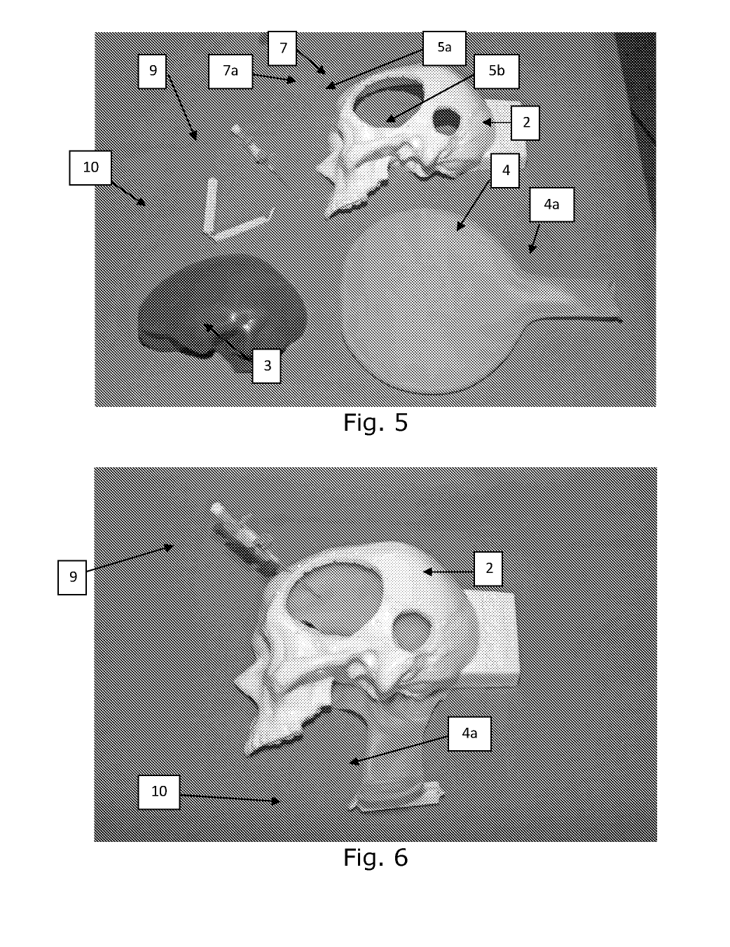

FIGS. 5-12 show a further embodiment of a medical training device according to the present invention and show surgical procedures using the medical training device 1. It is noted that although the surgical procedures are shown in connection with a specific embodiment, they can also be carried out on other embodiments falling within the scope of the present invention. Same numerals as used in the foregoing figures have been used to designate similar or identical parts in FIGS. 5-12.

With reference to FIG. 5, the medical training device 1 may preferably comprise an outer element 2 and/or an inner element 4 as disclosed in connection with FIGS. 1-4. The box-shaped part at the back of the skull is used for handling purposes and may be left out. Thus, the medical training device 1 of FIGS. 5-12 comprises an outer element 2 in form of a left half skull with two openings 5a, 5b (craniotomies), bores (suture holes) 7 and a bore 7a for inserting a cannula, an inner element 3 inform of a silicone left half brain, and an intermediate element 4 in form of a rubber—typically latex—balloon, a cannula 9 and a clamp 10 for sealing the intermediate element 4 at a mouth piece 4a thereof. The intermediate element 4 when sealed by the clamp defines a fluid tight enclosure.

FIG. 6 shows the medical training device 1 in an assembled state in which intermediate element 4 is placed on top of the inner element 3, and the inner element 3 and the intermediate element 4 are both arranged inside the cavity defined by the outer element 2, except the mouth piece 4a of the intermediate element 4 which as shown in FIG. 6 extends outside from the outer element 2. The mouth piece 4a of the intermediate element 4 is closed in a fluid tight manner by the clamp 10.

As the intermediate element 4 being balloon shaped and arranged between the inner element 3 and the outer element 2, as shown in FIG. 5, the intermediate element 4 provides two layers present in between the outer element 2 and the inner element 3. The layers of the intermediate layers thereby provided are termed top layer and bottom layer, where top layer refers to the layer being closest to the outer element 2 and bottom layer refers to the layer being closest to the inner element 3. It is normally not necessary to require that the inner element 3 is arranged fully inside the cavity of the outer element 2.

The assembly and training procedure for the medical training device 1 of FIGS. 5-12 typically follow the following consecutive steps:
the intermediate element 4 is closed with the clamp 10 applied to the mouth piece 4a of the intermediate element 4,
the intermediate element 4 is placed on top of the inner element 3,
the outer element 2 is placed on top of the inner element 3 and the intermediate element 4, optionally the inner element 3 is fixed to the outer element 2,
the cannula 9 is inserted through the bore 7a of the outer element 2, penetrating only the top layer of the intermediate element 4,

Further steps are disclosed in details with reference to the following figures.

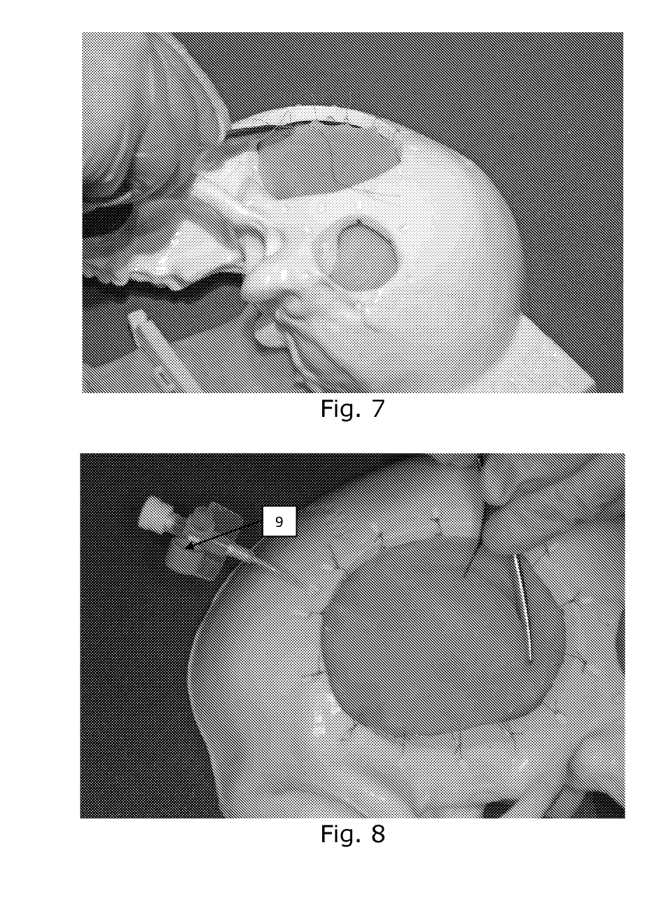

In FIG. 7, the top layer of the intermediate element 4 is suspended (fixated) to the outer element 2 using the bores 7 (suturing holes) and in FIG. 8 incision of the top layer of intermediate element 4 is performed.

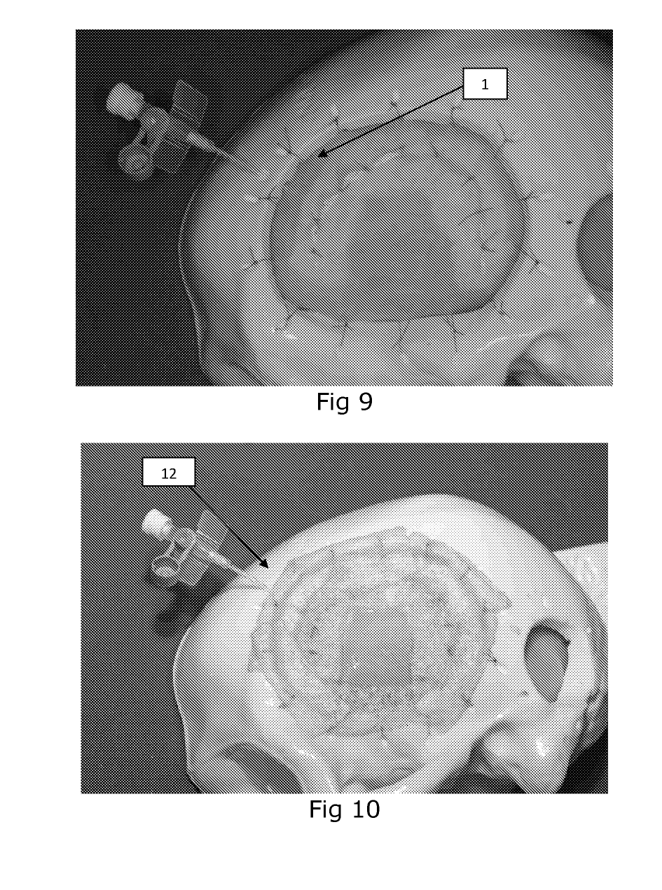

In FIG. 9 a surgical haemostasis/sealing sponge TachoSil® is placed between the two layers of the intermediate element 4 with the active side facing the inner surface (that is the surface facing towards the bottom layer) of the top layer of the intermediate element 4. The incision of the intermediate element 4 is closed by suturing.

Once the procedures disclosed in FIG. 9 have been performed, TachoSil® is applied to the outer surface (that is the surface facing upwardly in FIGS. 5-12) of the top layer of the intermediate element 4 as shown in FIG. 10. Visible in FIG. 10 is that TachoSil® is also applied along the rim of the opening 5a and covers the suturing along the rim of the opening 5a and the corresponding bores 7.

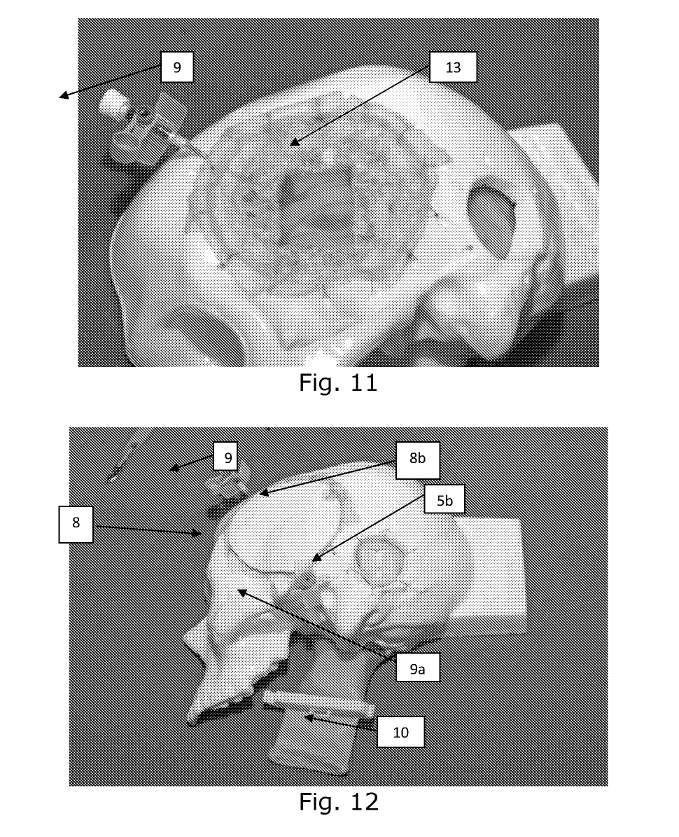

The sealing effect of TachoSil® is tested in FIG. 11. The sealing effect is tested by injecting coloured water through the cannula 9 into the intermediate element 4. As the intermediate element closed by the clamp 10 defines a fluid tight enclosure before incision and suturing being applied to the intermediate element 4, lack of leakage from the intermediate element of coloured water indicates successful sealing.

Finally, plug 8 (bone piece from large craniotomy) may be placed back into its site of origin as shown in FIG. 12 where plug 8 has been inserted into the opening 5a. FIG. 12 further shows surgical procedure repeated for small craniotomy (opening 5b and cannula 9a).

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements disclosed in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A medical training device comprising at least three elements:
an outer element imitating an outer bony structure of a human or animal body;
an inner element imitating a human or animal organ; and
an intermediate element arranged between the outer element and the inner element and imitating a meninge, of a human or animal body, wherein
said intermediate element being elastic and arranged in a tension state so that a puncture or fracture applied to the intermediate element results in an enlargement of the puncture or fracture.

2-13. (canceled)

14. The medical training device according to claim 1, wherein the outer element is formed as a shell defining a cavity and wherein the inner element is arranged inside the cavity.

15. The medical training device according to claim 1, wherein the outer element is imitating at least a part of a skull, the inner element imitating at least a part of a brain, and the intermediate element imitating at least a part of one or more of the layers of the meninges surrounding the brain and spinal cord.

16. The medical training device according to claim 1, wherein the intermediate layer is fixated by a fixation being provided in a bottom part of the device by mutually shaping the inner element and the outer element so that when the inner element is inserted in the outer element, the distance between the outer surface of the inner element and inner surface of the outer element in the contraction is smaller than the thickness of the intermediate element.

17. The medical training device according to claim 1, wherein the intermediate element is balloon-shaped having a mouth piece and the inner element is arranged inside the intermediate element, the volume of the intermediate element in a non-tensioned state is smaller than the volume of the inner element, so that tension to the intermediate element is provided by the stretching of the intermediate element resulting from arranging the inner element in the intermediate element.

18. The medical training device according to claim 1, wherein the intermediate element is balloon shaped having a mouth piece, and wherein the intermediate element is arranged between the outer element and the inner element so that two layers are defined by the intermediate element between the inner element and the outer element, and wherein the intermediate element when sealed at the mouth piece defines a fluid tight enclosure.

19. The medical training device according to claim 1, wherein the inner element and the outer element are mutually shaped to provide a firm fitting of the inner element into the outer element and that tension provided to the intermediate element is maintained by the firm fit.

20. The medical training device according to claim 1, wherein the inner element is made from silicone, the intermediate element is made from latex and the outer element is made from a material being stiffer than silicone.

21. The medical training device according to claim 1, wherein one or more through going openings are provided in the outer element providing access to the intermediate element.

22. The medical training device according to claim 21, comprising a number of bores provided along the rims of the through going opening(s), the bores are sloping and extend from a position away from the rim of the through going opening(s) to an edge between the inner surface of the inner element and the surface of the through going opening(s).

23. A training method comprising the execution of the following steps on a device according to claim 1:
fixating the intermediate layer prior to providing a penetration imitating an surgery opening in the intermediate layer by suturing the intermediate layer to the outer element along a rim of a through going opening in the outer element,
providing the penetration of the intermediate layer inside a region defined by the through going opening in the outer element, and
applying dressing, to the penetration(s) and suturing(s) made in the intermediate layer.

24. The training method according to claim 23, further comprising leak testing sealing provided by the applied dressing by injecting liquid, between the intermediate element and the inner element.

25. The training method according to claim 23, wherein the intermediate element is balloon shaped having a mouth piece, and wherein the intermediate element is arranged between the outer element and the inner element so that two layers are defined by the intermediate element between the inner element and the outer element, and wherein the intermediate element when sealed at the mouth piece defines a fluid tight enclosure, further comprising leak testing sealing provided by the applied dressing by injecting liquid between the two layers of the intermediate element when dependent on claim 18.
